(19) United States
(12) Patent Application Publication
(10) Pub. No.: US 2004/0263082 A1
(43) Pub. Date: Dec. 30, 2004

(54) Sculpted free-form light bulb and method of producing the same

(76) Inventors: Ulrich Daucher, Paranaque (PH); Michael Hermann Schneck, Pasig City (PH)

Correspondence Address: SHOEMAKER AND MATTARE, LTD, 10 POST OFFICE ROAD - SUITE 110, SILVER SPRING, MD, 20910, US

(21) Appl. No.: 10/874,811

(22) Filed: Jun. 24, 2004

(30) Foreign Application Priority Data
Jun. 24, 2003 (PH) 2-2003-000236

(51) Int. Cl. H01J 17/16; H01J 61/30

(52) U.S. Cl. 313/634; 313/493

(57) ABSTRACT

A sculpted free-form light bulb has a body formed to simulate desired shapes of an object having a capping at one end and provided inside with a filament adapted to operate as a normal light bulb. A method of making the bulb includes steps of: making a sculpt out of resin in a desired shape (e.g., a teddy bear), translating that sculpt into a metal mold, blowing the metal mold at a temperature around 1150° C. at a pressure around 3 psig to form a bulb having that desired shape, sealing the bulb by placing a filament inside, capping the bulb, basing the bulb, and testing the bulb by placing it into a light testing machine.

### FIELD OF THE INVENTION

This invention relates in general to light bulbs and more particularly to sculpted free-form light bulbs and method of producing the same.

### BACKGROUND OF THE INVENTION

Standard light bulbs are mostly formed in only one standard shape with the broad bulging portion at the lower end thereof. Although it has accomplished its intended purpose, experience dictates that if the shape could be modified in such a way as to provide aesthetic effect to the sense of sight and could be appropriately used to symbolize a particular occasion, such bulb could better serve its user.

A need therefore exists to provide a pre-form light bulb that could be sculpted to the shape as desired by the user that not only provides glowing light to the occasion but symbolizes the occasion as well.

Thus, there remains a clear need for a sculpted pre-form light bulb and method of producing the same to remedy the aforementioned drawback.

### SUMMARY OF THE INVENTION

Toward providing these and other advantages, the present invention is a sculpted free-form light bulb that operates like a conventional light bulb with an attached filament inside. The light bulb of the subject invention can be sculpted to any desired shape, which fits the demand or occasion to be celebrated. It can be in the form of characters like teddy bear, Santa Claus, Easter bunny, angel, Halloween ghosts, heart, any fruits or vegetables, cars, animals, cartoon characters, spaceships, rockets, flowers and any nondescript form, in fact any desired shape can be sculpted.

Another aspect of the present utility model is the method of making the sculpted free-form light bulb which comprises the steps of making a mold out of plaster, translating the mold into a metal mold, blowing the bulb using the metal mold to come up with the desired sculpted pre-form light bulb, and putting a filament to the bulb.

These and other objects of the invention will come to light upon reading the following description taken in conjunction with the appended drawings.

### BRIEF DESCRIPTION OF THE DRAWINGS

FIG. 1 is a perspective view of the sculpted free-form light bulb in this example simulating a teddy bear embodying subject invention;

FIG. 2 is a perspective view of another embodiment of subject invention simulating the shape of a heart; and

FIG. 3 is a process flow diagram of the method of making a sculpted free-form light bulb.

### DESCRIPTION OF THE PREFERRED EMBODIMENT

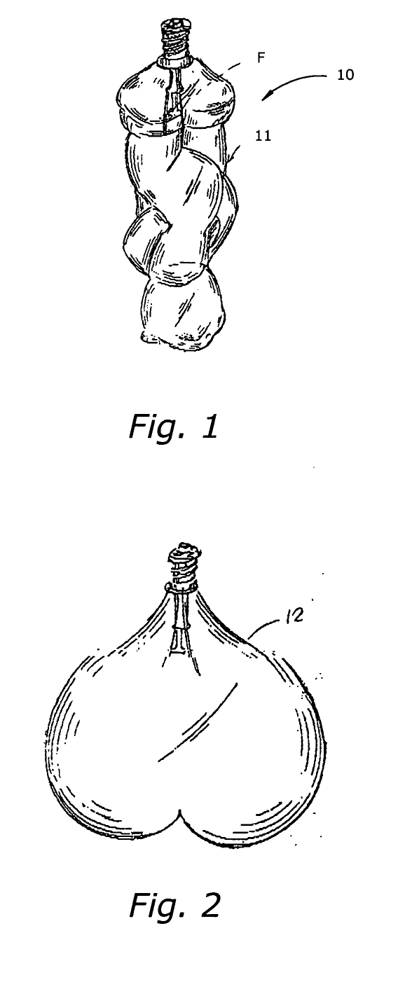

Referring now to the drawings in detail wherein like numerals designate same parts throughout, there is shown in FIG. 1 a sculpted free-form light bulb generally designated as 10, which comprises a body formed in a desired shape of character simulating a teddy bear 11 provided inside with a filament F. The light bulb is removable connected to an electrical source at a predetermined location and then switched on to operate like a normal bulb (not shown.) As shown the light bulb 10 has the capping at its bottom portion of the teddy bear 11 showing its upside down position. The capping however, is not limited to this position and can be placed also at the top portion of the teddy bear 11 showing the standard upright position.

As shown in FIG. 2 the sculpted free-form light bulb comprises a body 12 formed into a heart like shaped object. Such variation in shape depends upon the likes of the user and is adapted for appropriate use to symbolize an occasion being celebrated. The same functions as a normal light bulb as described above.

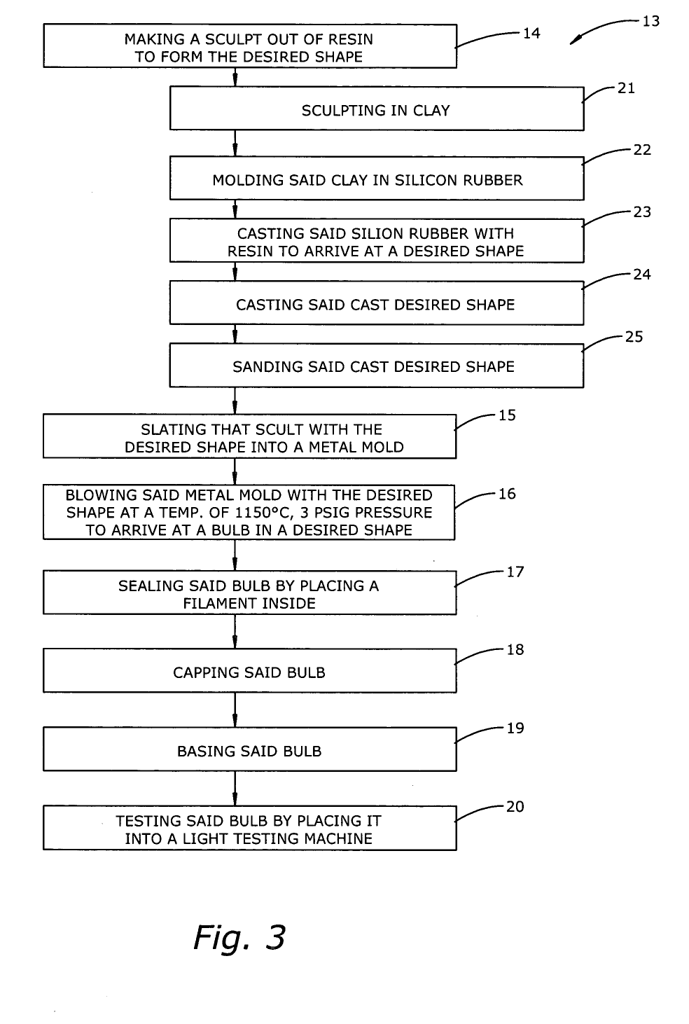

The method of making the sculpted free-form light bulb, shown in FIG. 3, comprises the steps of making a sculpt out of resin to form the desired shape 14, translating that sculpt with the desired shape into a metal mold 15, blowing the metal mold with the desired shape at a temperature around 1,150 degrees Celsius and pressure around 3 psig to arrive at a bulb in a desired shape 16, sealing the bulb by placing a filament inside 17, capping the bulb 18, basing the bulb 19 and testing the bulb by placing it into a light testing machine 20.

The making a sculpt out of resin 14 includes the steps of sculpting in clay 21, molding the clay in silicon rubber 22, casting the silicon rubber with resin to arrive at a desired shape 23, (e.g. teddy bear), cleaning the cast desired shape 24 and sanding the cast desired shape 25.

The present invention being thus far described and illustrated in detail, it is obvious that these description and drawings only represent an example of the present invention, and should not be interpreted as limiting the invention. The spirit and scope of the invention is only limited by the words used in the accompanied claims.

We claim:

1. A sculpted free-form light bulb comprising a body formed to simulate desired shapes of an object having a capping at one end and provided inside with a filament adapted to operate as a normal light bulb.

2. A sculpted free-form light bulb in accordance with claim 1, wherein said shapes are selected from the group consisting of teddy bear, Santa Claus, Easter bunny, angel, Halloween ghosts, heart, fruits, vegetables, cars, animals, cartoon characters, spaceships, rockets, flowers, and arbitrary forms.

3. A method of making sculpted free-form light bulb comprising the steps of:
a. making a sculpt out of resin to form a desired shape;
b. translating that sculpt with that desired shape into a metal mold;
c. blowing said metal mold with that desired shape at a temperature around 1150° C. at a pressure around 3 psig to arrive at a bulb having that desired shape;
d. sealing said bulb by placing a filament inside;
e. capping said bulb;
f. basing said bulb; and
g. testing said bulb by placing it into a light testing machine.

4. A method of making sculpted free-form light bulb in accordance with claim 3, wherein making a sculpt out of resin to form the desired shape includes the steps of:
a. sculpting in clay;
b. molding said clay in silicon rubber;
c. casting said silicon rubber with resin to arrive at a desired shape;
d. cleaning said cast desired shape; and
e. sanding said cast desired shape.
